(19) United States
(12) Patent Application Publication
(10) Pub. No.: US 2025/0148702 A1
(43) Pub. Date: May 8, 2025

(54) Method for Monocular Acquisition of Realistic Three-Dimensional Scene Models

(71) Applicant: Cinemersive Labs Ltd, Ruislip (GB)

(72) Inventors: Victor Lempitskiy, Edinburgh (GB); Pavel Solovev, Edinburgh (GB)

(21) Appl. No.: 18/937,776

(22) Filed: Nov. 5, 2024

Related U.S. Application Data
(60) Provisional application No. 63/596,382, filed on Nov. 6, 2023.

(51) Int. Cl. G06T 15/40; G06T 15/20; G06T 17/00

(52) U.S. Cl. CPC G06T 15/40; G06T 15/205; G06T 17/00

(57) ABSTRACT

Systems and methods for creating a three-dimensional digital model of a scene from a two-dimensional input image of the scene are described. One aspect includes receiving the two-dimensional input image of the scene, and predicting a latent tensor from the input image. The latent tensor comprises three-dimensional geometrical information of the received two-dimensional input image and information about one or more surfaces occluded in the received two-dimensional input image. The latent tensor and the received two-dimensional image may be inputs to the reconstruction neural network that predicts a three-dimensional model. A paired dataset of input images and corresponding latent tensors may be obtained by a joint training of the reconstruction neural network and an encoding neural network that outputs latent tensors from multiview inputs. The process that predicts the latent tensor from the single input image may then be trained on the paired dataset.

### RELATED APPLICATION

This application claims the priority benefit of U.S. Provisional Application Ser. No. 63/596,382, entitled “Method and System for Three-Dimensional Scene Models,” filed Nov. 6, 2023, the disclosure of which is incorporated by reference herein in its entirety.

### BACKGROUND

### Technical Field

The present disclosure relates to systems and methods for acquiring three-dimensional scene models from single two-dimensional photographs captured by consumer digital cameras such as smartphone cameras

### Background Art

Realistic three-dimensional models of a static scene can be rendered on three-dimensional displays such as volumetric displays, virtual reality headsets and augmented reality headsets in such a way that the display has high realism comparable with regular photographs. In such renderings the user can observe the captured environment from a range of viewpoints, conveying a strong sense of immersion into the scene.

### Acquisition of Three-Dimensional Models

Traditionally, three-dimensional models can be captured from reality using stereo camera setups. This process can be performed by processing the input from such setups using computer vision algorithms. Such algorithms are often referred to as multi-view stereo reconstruction algorithms or photogrammetry algorithms. Three-dimensional models of static scenes where no motion occurs or such motion can be disregarded can also be obtained by (1) acquiring a sequence of photographs or video frames with a moving camera, (2) estimating the relative positions and orientations of the camera at the moments these frames or photographs were captured using so-called structure-and-motion algorithms and (3) once again applying multi-view stereo reconstruction algorithms.

### Monocular Acquisition

There is a growing interest in monocular acquisition of three-dimensional models. In one aspect, monocular acquisition relates to reconstruction based on a single two-dimensional photograph acquired with a digital camera (such as a smartphone camera). The acquisition of three-dimensional photographs requires the inference of information that is not directly observable in the input data, such as recovering depths, photometric properties of the surfaces, as well as both geometric and photometric properties of the occluded parts of the scene.

Monocular acquisition relies on the combination of one or more monocular cues governed by projective geometry, as well as on the semantic knowledge about objects in the scene, namely their typical shapes, sizes, and texture patterns. In recent years, monocular acquisition is performed within the machine learning approach, so that such cues are learned on a training dataset that usually contain images and three-dimensional scene models. Alternatively, approaches that perform learning without three-dimensional models based on multi-view geometry have been proposed. The proposed systems and methods relate to the latter category.

### Denoising Diffusion Probabilistic Models

Monocular acquisition is an inherently one-to-many prediction problem, since for a given photograph multiple plausible 3D scene models compatible with the said photograph exist that may differ, among other things, in the geometric configuration and textures of the parts of the scene that are not visible in the said photograph. Such one-to-many prediction tasks are hard for traditional machine learning approaches. For example, standard regression models trained using supervised learning often exhibit regression-to-mean effects, predicting the averaged answer over many possibilities, which in many practical cases does not correspond to a plausible solution to the prediction task.

Recently, denoising diffusion probabilistic models (DDPMs) have offered a boost in the ability to learn such one-to-many mappings. The denoising diffusion approach produces the answer iteratively, by reversing the Markov chain that gradually adds noise to data. This is achieved by iterative prediction of the answer given the input (condition) and the noisy version of the answer, and then adding noise with progressively diminishing amplitude to the previously predicted version of the answer. The prediction is performed by a neural network (the denoising network).

DDPMs provide the state-of-the-art both in terms of the plausibility of predictions and the stability and ease of the learning process. While the iterated denoising process used by DDPMs during inference may incur a large number of neural network evaluations and therefore be slow, considerable strides towards reducing the number of evaluations without compromising the quality of predictions have been made. In particular, performing denoising in the latent space of smaller dimensionality in order to reduce the resource consumption during training and inference has been suggested and has become a popular approach.

### SUMMARY

In one embodiment of the present invention, a three-dimensional model of a scene is reconstructed from an input photograph of the scene and a latent tensor containing additional information required to reconstruct the three-dimensional scene, by inputting the input photograph and the latent tensor into a neural reconstruction network and obtaining the three-dimensional model as the output of the reconstruction network.

In another embodiment of the present invention, the three-dimensional model of a scene has a form of a textured mesh, wherein the geometry of the mesh comprises several layers and wherein the texture of the mesh defines local color and transparency at each element of the geometric surface.

In another embodiment of the present invention, the said three-dimensional model of a scene has a form of a volumetric model.

In another embodiment of the present invention, a paired dataset of input photographs and corresponding latent tensors is obtained by joint learning of the combination of the encoder network and the reconstruction network, whereas the learning is performed on a dataset, where each entry is a multiplicity of auxiliary images of the scene depicted in a certain set of input photographs taken from different viewpoints, and whereas the encoder network takes a multiplicity of auxiliary images of a scene as input and produces the corresponding latent tensor as output.

In another embodiment of the present invention, the objective of the learning in each learning step is obtained by taking the multiplicity of auxiliary images, passing them through the encoder network thus obtaining the latent tensor, passing the resulting latent tensor and the input photograph through the reconstruction network thus reconstructing the three-dimensional scene model, and finally evaluating how well the differentiable rendering of the reconstructed three-dimensional scene onto the coordinate frames of each of the auxiliary images matches the auxiliary image.

In another embodiment of the present invention, during the reconstruction of the three-dimensional scene from the input photograph, the latent tensor that corresponds to the input photograph is obtained from the input photograph using a denoising diffusion process driven by a pretrained denoising network.

In another embodiment of the present invention, the denoising network is trained on the said paired dataset.

In another embodiment of the present invention, during the reconstruction of the three-dimensional scene from the input photograph, the latent tensor that corresponds to the input photograph is obtained from the input photograph using a pretrained auto-regressive network.

In another embodiment of the present invention, the auto-regressive network is trained on the said paired dataset.

In another embodiment of the present invention, during the reconstruction of the three-dimensional scene from the input photograph, the latent tensor that corresponds to the input photograph is obtained from the input photograph using a pretrained image translation network.

In another embodiment of the present invention, the said image translation network is trained on the paired dataset.

In another embodiment of the present invention, the image translation network is trained on the said paired dataset using adversarial learning.

In another embodiment of the present invention, the three-dimensional scene reconstruction process is applied to individual frames of a video taken by a single digital camera, and the resulting three-dimensional reconstructions are assembled and post-processed into a coherent three-dimensional video.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 depicts a general scheme for monocular reconstruction.

FIG. 2 depicts a neural network architecture to generate a 3D scene from one or more input images

FIG. 3 depicts an algorithm for obtaining monocular reconstruction after a main architecture has been trained.

FIG. 4 depicts a process of training of a denoising network for a denoising diffusion process, which can be used for monocular reconstruction.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention described herein present a neural network-based architecture configured to generate one or more three-dimensional scene models from single two-dimensional images. These images may be captured by consumer digital cameras such as smartphone cameras.

Some aspects of the invention relate to the acquisition of static models (which are sometimes referred to as three-dimensional photographs). The systems and methods described herein can also be used for the acquisition of three-dimensional videos, where each frame is a 3D model that allows display in 3D with high realism. In different contexts, variants of such videos are sometimes called free-viewpoint videos, volumetric videos or immersive videos.

### System Overview

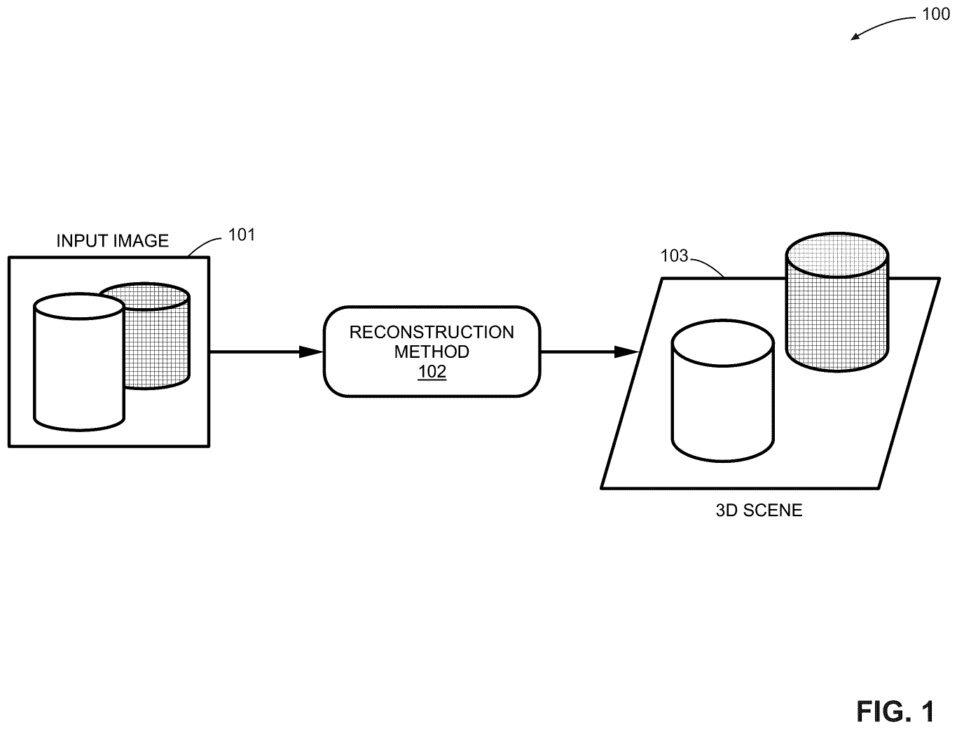

FIG. 1 depicts a general scheme 100 for monocular reconstruction. As depicted, reconstruction method 102 receives one or more input images 101, and converts input images 101 into one or more 3D scenes 103. In an aspect, input image 101 can be any combination of still images captured by one or more digital still cameras, or scanned digital images. The systems and methods described herein describe reconstruction method 102, that generates 3D scene 103 based on input image(s) 101.

### System Architecture

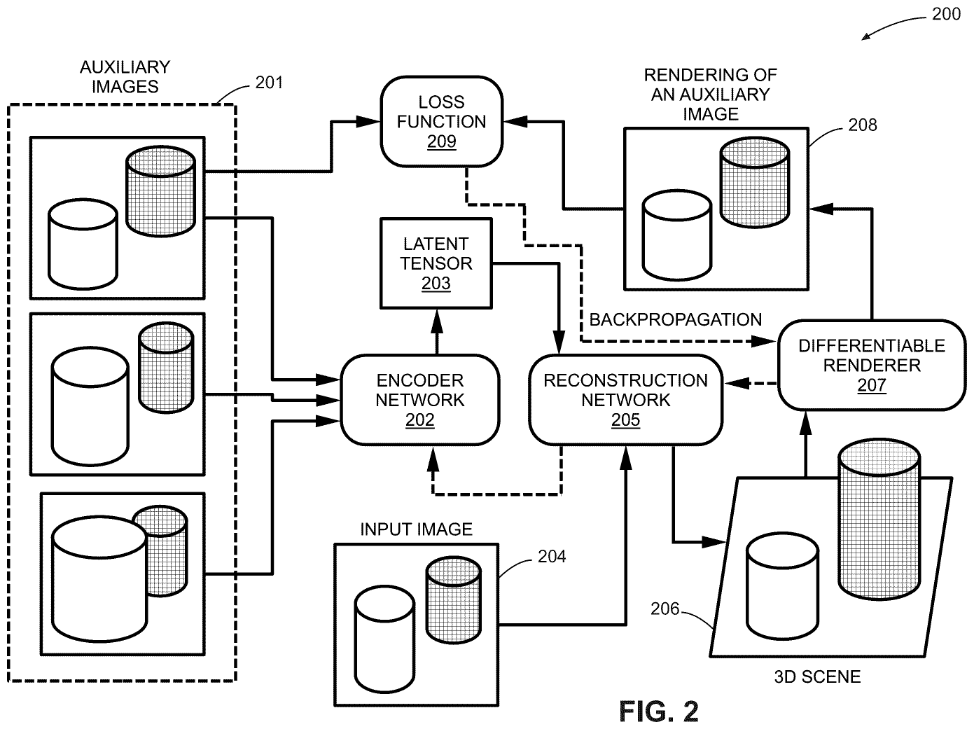

FIG. 2 depicts a neural network architecture 200 to generate a 3D scene from one or more input images. In one aspect, neural network architecture 200 is trained based on a dataset of multiplicities of images (e.g., one or more multi-view datasets), and the result of the learning is further used for monocular reconstruction. Each entry of the multi-view dataset contains a tuple of auxiliary images 201 of the same scene. Such tuples can be obtained either using a synchronized camera rig or by taking multiple frames from a video taken using a moving camera assuming that the scene being filmed is static or near static.

A neural network called an encoder network 202 is then used to transform the tuple 201 into a latent tensor 203 that contains the information about the three-dimensional structure of the scene associated with auxiliary images 201. In an aspect, this property of the tensor emerges automatically as a product of the learning process discussed subsequently. The encoder network 202 can have different architectures. For example, it can be assumed that the relative position in space of the auxiliary images is known and the images are then unprojected onto a three-dimensional volumetric grid, which is further processed with a convolutional network producing a two-dimensional multi-channel latent tensor 203.

In the next stage, the input image 204 is considered. Such an input image can be a part of the tuple 201, or it can be a separate image. In one embodiment, input image 204 is spatially aligned with the latent tensor 203. The input image 204 and the latent tensor 203 are then passed through the reconstruction network 205 that outputs the 3D scene 206. The reconstruction network 205 and the 3D scene 206 can take multiple forms. For example, in one embodiment, the reconstruction network 205 has a convolutional architecture, and the output has the form of multiple layers that can be planar or spherical, while the reconstruction network 205 predicts local color and transparency maps. In another embodiment, the convolutional reconstruction network 205 further predicts local offsets to the planar or spherical layers to enable finer control over the geometry of the 3D scene 206.

In one aspect, the encoder network 202 and the reconstruction network 205 are trained jointly. The objective function of the learning/training can include multiple terms standard for 3D reconstruction tasks. In particular, the main learning objective can be obtained using a differentiable renderer 207. The predicted 3D scene 206 can be projected (rendered) onto a coordinate frame of one of the auxiliary images 201, and a result of such rendering 208 can be compared with the original image (e.g., input image 204). The comparison can be made using a loss function 209, which can be any of the standard loss functions used in machine learning/computer vision, for example, a sum of absolute pixel differences. The resulting loss associated with loss function 209 can be backpropagated through the differentiable renderer 207 into the reconstruction network 205 and further into the encoder network 202, and the parameters of the said networks can be updated using a variant of a stochastic gradient descent algorithm, thus concluding one step of an iterative learning process.

In one aspect, the encoding process performed using the encoder network 202 is compressive, i.e. the latent tensor 203 is of smaller size and has less information content than the input auxiliary image tuple 201. This is achieved by limiting the size of the tensor. Furthermore, the information about the 3D scene that can be easily recovered from the input image 204 (such as the texture of the surfaces visible in the input image) is naturally squeezed out (i.e., extracted) from the latent tensor 203 diminishing the information content inside this tensor, and making it easier to reconstruct. This is used in the monocular reconstruction process described subsequently.

Embodiments of neural network architecture 200 may be implemented on a processing system comprising at least one processor, a memory, and network connection. Examples of processing systems that can be used to implement neural network architecture include personal computing architectures, microcontrollers, digital signal processors (DSPs), field-programmable gate arrays (FPGAs), cloud computing architectures, embedded processing systems, and so on. For example, any combination of encoder network 202, reconstruction network 205, and differentiable renderer 207 can be implemented on a processing system.

### Monocular Reconstruction Process

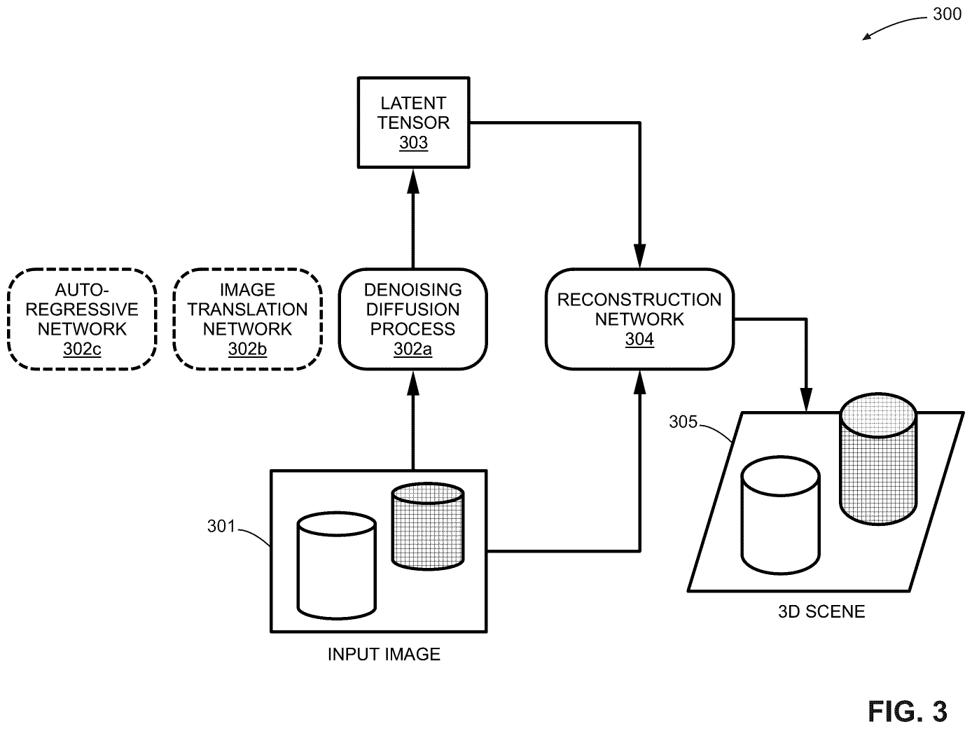

FIG. 3 depicts an algorithm 300 for obtaining monocular reconstruction after a main computing architecture (e.g., neural network architecture 200) has been trained.

The monocular reconstruction 300 is performed in two steps. First, at 302, a latent tensor 303 that corresponds to an input image 301 is reconstructed. In one aspect, input image 301 is similar to input image 204. The process 302 of generating latent tensor 303 can be performed in several different ways. In one aspect, 302 can be performed as a learned denoising diffusion process 302a, which is further detailed below and is based around a denoising network (described subsequently). Alternatively, latent tensor 303 can be predicted directly from input image 301 using a feed-forward image translation network 302b. Alternatively, the latent tensor 303 can be predicted from the input image 301 using an auto-regressive network 302c.

Irrespective of the design choice between a diffusion process (associated with denoising diffusion process 302a), an image translation process (associated with image translation network 302b), or an autoregressive process (associated with auto-regressive network 302c), the denoising network, the image translation network 302b, or the auto-regressive network 302c need to be trained on a paired dataset of input images and the corresponding latent tensors. Such paired dataset can be obtained from the learning/training process depicted in FIG. 2. Specifically, after encoder network 202 and reconstruction network 205 are learned/trained, the latent tensor corresponding to the input image can be obtained for each entry of the original dataset used for the learning process. Each training pair then corresponds to the pair of latent tensor 203 and input image 204.

Returning to the monocular reconstruction process 300, once latent tensor 303 has been reconstructed from input image 301, both latent tensor 303 and input image 301 are passed through reconstruction network 304 (which is a copy of the learned/trained version of reconstruction network 205), that produces 3D scene 305. This concludes the monocular reconstruction process.

In one aspect, monocular reconstruction process 300 is based on the idea that information content and the size of latent tensor 303 are relatively small compared to the size and the information content of the 3D scene for the reasons discussed above. Therefore, it is easier to reconstruct latent tensor 303 from input image 301 than to reconstruct 3D scene 305 from input image 301 directly.

Embodiments of neural networks used for architecture 200 or monocular reconstruction process 300 may each be implemented as a deep neural network comprised of one or more convolutional layers, one or more self-attention layers, or one or more cross-attention layers.

### Monocular Reconstruction Through Denoising Diffusion

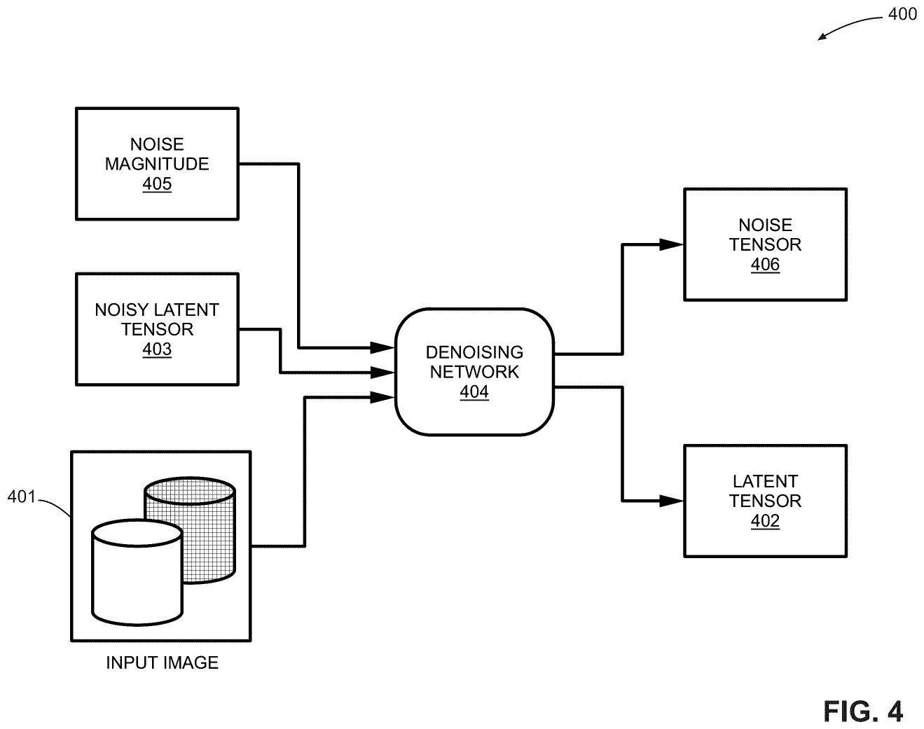

FIG. 4 depicts a process 400 of training of a denoising network for a denoising diffusion process (e.g., process 302a), which can be used for monocular reconstruction. In an aspect, process 400 enables a reconstruction of latent tensor 303 from an input image (e.g., input image 301). Such process requires a learned/trained denoising network 404. The learning/training process may be implemented in iterative steps. In each step a pair of input image 401 and the corresponding latent tensor 402 are drawn from the dataset. A random noise magnitude 405 is drawn from some distribution associated with a random variable (e.g., a uniform distribution), and a noisy version 403 of the latent tensor 402 is created by adding independent random values (noise) to each latent tensor entry.

In one aspect, denoising network 404 then takes as an input the input image 401 and the noisy version 403 of the latent tensor as well as a parameter (e.g., magnitude) of the noise 405. The denoising network 404 then predicts either the original noise-free latent tensor 402 or the noise tensor 406 (or their weighted combination with predefined weights). During learning, the parameters of the denoising network 404 are optimized to make the predictions as accurate as possible.

Once the denoising network 404 is trained through the said optimization of parameters, it can be used to reconstruct the latent tensor 303 from the input image 301 through the denoising diffusion process 302a.

### Additional Loss Functions for the Latent Prediction Process

The denoising network 404/302a, the image translation network 302b, as well as the autoregressive network 302c can all be learned/trained with additional losses that take the reconstruction network 304 into account. For example, an additional loss term can compare the 3D reconstructions obtained by the reconstruction network 304 from the predicted latent tensor and from the latent tensor 402 recorded in the dataset. This additional loss term can be backpropagated through the reconstruction network 304 into the networks 302a, 302b, and/or 302c that accomplish the latent prediction process.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method for creating a three-dimensional digital model of a scene from a two-dimensional input image of the scene, the method comprising:
receiving the two-dimensional input image of the scene;
predicting a latent tensor from the input image, wherein the received two-dimensional input image is input to a prediction process, wherein the latent tensor comprises three-dimensional geometrical information of the received two-dimensional input image and information about one or more surfaces occluded in the received two-dimensional input image; and
reconstructing the three-dimensional digital model via a reconstruction neural network, wherein the latent tensor and the received two-dimensional image are inputs to the reconstruction neural network.

2. The method of claim 1, wherein the prediction process is a denoising diffusion process, an image-to-image translation network, or an auto-regressive network.

3. The method of claim 1, wherein the reconstruction neural network is a deep neural network comprised of one or more convolutional layers, one or more self-attention layers, or one or more cross-attention layers.

4. The method of claim 1, further comprising generating a paired training data set, the generating further comprising:
obtaining a plurality of auxiliary images of a training scene taken from different viewpoints;
inputting each of the plurality of auxiliary images and a reference image into an encoder neural network; and
obtaining, via an output of the encoder neural network, a trained latent tensor that comprises three-dimensional geometrical information about the training scene and information about one or more surfaces occluded in the reference image, wherein the reference image and the trained latent tensor constitute an entry in the paired training data set.

5. The method of claim 4, further comprising joint training of the encoder neural network and the reconstruction neural network, the method comprising:
reconstructing a three-dimensional digital training model via the reconstruction neural network, wherein the paired training data set entries are inputs to the reconstruction neural network;
rendering a two-dimensional auxiliary image via a differentiable renderer wherein the three-dimensional digital training model is input into the differentiable renderer;
calculating a loss function via a comparison of the rendered two-dimensional auxiliary image and at least one of the plurality of auxiliary images of the training scene or the reference image; and
inputting the calculated loss function into any combination of the encoder neural network, prediction process, and the reconstruction neural network.

6. The method of claim 4, wherein the prediction process is trained on the paired training dataset, such that a corresponding trained latent tensor is computed for each of the plurality of auxiliary images.

7. A system for creating a three-dimensional digital model of a scene from a two-dimensional input image of the scene, the system comprising:
a processor configured to execute a prediction process to predict a latent tensor based on the two-dimensional input image, wherein the latent tensor comprises three-dimensional geometrical information of the received two-dimensional input image and information about one or more surfaces occluded in the received two-dimensional input image; and
a reconstruction neural network configured to receive the latent tensor and the received two-dimensional image as inputs, wherein reconstruction neural network is further configured to reconstruct the three-dimensional digital model.

8. The system of claim 7, wherein the prediction process is implemented via any of denoising diffusion process, an image translation network, or an auto-regressive network.

9. The system of claim 7, wherein the reconstruction neural network is a deep neural network comprised of one or more convolutional layers, one or more self-attention layers, or one or more cross-attention layers.

10. The system of claim 7, wherein the system further comprises:
an encoder network configured to receive a plurality of auxiliary images of a training scene taken from different viewpoints and a reference image as input, said encoder network further configured to output a trained latent tensor that comprises three-dimensional geometrical information about the training scene and the information about one or more surfaces occluded in the reference image, wherein the reference image and the trained latent tensor constitute an entry in the paired training data set.

11. The system of claim 10, further comprising:
the reconstruction network configured to receive the trained data set and output a reconstructed three-dimensional training model of the training scene;
a differentiable renderer configured to receive as input the three-dimensional digital training model and render a two-dimensional auxiliary image based on said three-dimensional digital training model;
a processor or a loss function unit configured to calculate a loss function based on a comparison of the rendered two-dimensional auxiliary image of the training scene and at least one of the plurality of auxiliary images or the reference image; and
any combination of the encoder neural network, prediction process and the reconstruction neural network further configured to receive the calculated loss function for training.

12. A machine-readable storage medium storing a set of instructions that are executable by one or more processors of a system for creating a three-dimensional digital model of a scene from a two-dimensional input image of the scene, wherein the set of instructions are configured to perform the method of claim 1.

13. A method for training a prediction process, the method comprising:
obtaining a plurality of auxiliary images of a training scene taken from different viewpoints;
inputting each of the plurality of auxiliary images and a reference image into an encoder neural network;
obtaining, via an output of the encoder neural network, a trained latent tensor that comprises three-dimensional geometrical information about the training scene and information about one or more surfaces occluded in the reference image, wherein the reference image and the latent tensor constitute an entry in the paired training data set.

14. The method of claim 13, further comprising jointly training the encoder neural network and the reconstruction neural network, the method comprising:
reconstructing a three-dimensional digital training model via the reconstruction neural network, wherein the paired training data set entries are inputs to the reconstruction neural network;
rendering a two-dimensional auxiliary image via a differentiable renderer, wherein the three-dimensional digital training model is input into the differentiable renderer;
calculating a loss function via a comparison of the rendered two-dimensional auxiliary image and at least one of the plurality of auxiliary images of the scene or the reference image; and
inputting the calculated loss function into any combination of the encoder neural network, prediction process and the reconstruction neural network.

15. A system for training a prediction process, the method comprising:
an encoder network configured to receive a plurality of auxiliary images of a training scene taken from different viewpoints and a reference image as input, said encoder network further configured to output a trained latent tensor that comprises three-dimensional geometrical information about the training scene and information about one or more surfaces occluded in the reference image, wherein the reference image and the trained latent tensor constitute an entry in the paired training data set, and the prediction process is trained via the paired training data set.

16. The system of claim 15 further being configured to jointly train the encoder neural network and a reconstruction neural network, the system further comprising:
a reconstruction network configured to receive the trained data set and output a reconstructed three-dimensional training model of the training scene;
a differentiable renderer configured to receive as input the three-dimensional digital training model and render a two-dimensional auxiliary image based on said three-dimensional digital training model;
a processor or a loss function unit configured to calculate a loss function based on a comparison of the rendered two-dimensional auxiliary image of the training scene and at least one of the plurality of auxiliary images or the reference image; and
any combination of the encoder neural network, prediction process and the reconstruction neural network further configured to receive the calculated loss function for training.

17. A machine-readable storage medium storing a set of instructions that are executable by one or more processors of a system for training, wherein the set of instructions are configured to perform the method of claim 13.
